(19) United States
(12) Patent Application Publication
(10) Pub. No.: US 2017/0081247 A1
(43) Pub. Date: Mar. 23, 2017

(54) SUPERHARD PCD CONSTRUCTIONS AND METHODS OF MAKING SAME

(71) Applicant: Element Six (UK) Limited, Oxfordshire (GB)

(72) Inventors: Nedret CAN, Oxfordshire (GB); Melisha NAIDOO, Springs (ZA); Carlo VISINTAINER, County Clare (IE)

(21) Appl. No.: 15/126,644

(22) PCT Filed: Mar. 18, 2015
(86) PCT No.: PCT/EP2015/055723

§ 371 Date: Sep. 16, 2016

(30) Foreign Application Priority Data
Mar. 18, 2014 (GB) 1404782.3

(51) Int. Cl. C04B 35/52; B24D 18/00; B01J 3/06; C22C 26/00; C04B 35/626; C04B 35/645

(52) U.S. Cl. CPC C04B 35/52; C04B 35/6268; C04B 35/645; B01J 3/062; C22C 26/00; B24D 18/0009; C04B 2235/425; C04B 2235/5481; C04B 2235/5436; C04B 2235/616; C04B 2235/656; C04B 2235/6581; C04B 2235/723; C04B 2235/786; B01J 2203/062; B01J 2203/0655; B01J 2203/0685; C22C 2204/00

(57) ABSTRACT

A polycrystalline super hard construction comprises a body of polycrystalline diamond (PCD) material and a plurality of interstitial regions between inter-bonded diamond grains forming the polycrystalline diamond material. The body of PCD material comprises a working surface positioned along an outside portion of the body, and a first region adjacent the working surface, the first region being a thermally stable region. The first region and/or a further region and/or the body of PCD material has/have an average oxygen content of less than around 300 ppm. A method of forming such a construction is also disclosed.

### FIELD

This disclosure relates to super hard constructions and methods of making such constructions, particularly but not exclusively to constructions comprising polycrystalline diamond (PCD) structures attached to a substrate and for use as cutter inserts or elements for drill bits for boring into the earth.

### BACKGROUND

Polycrystalline diamond (PCD) is an example of a super hard material (also called a superabrasive material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. A material wholly or partly filling the interstices may also be referred to as filler or binder material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide, which may be used to form a suitable substrate, is formed from carbide particles dispersed, for example, in a cobalt matrix by mixing tungsten carbide particles/grains and cobalt together then heating to solidify. To form the cutting element with an ultra-hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline super hard diamond or polycrystalline CBN layer.

In some instances, the substrate may be fully cured prior to attachment to the ultra-hard material layer whereas in other cases, the substrate may be green, that is, not fully cured. In the latter case, the substrate may fully cure during the HTHP sintering process. The substrate may be in powder form and may solidify during the sintering process used to sinter the ultra-hard material layer.

Polycrystalline super hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. Cutting elements such as those for use in rock drill bits or other cutting tools typically have a body in the form of a substrate which has an interface end/surface and an ultra-hard material which forms a cutting layer bonded to the interface surface of the substrate by, for example, the sintering process.

The working life of super hard tool inserts may be limited by fracture of the super hard material, including by spalling and chipping, or by wear of the tool insert. In many of these applications, the temperature of the PCD material may become elevated as it engages rock or other workpieces or bodies. Mechanical properties of PCD material such as abrasion resistance, hardness and strength tend to deteriorate at elevated temperatures, which may be promoted by the residual catalyst material within the body of PCD material as cobalt has a significantly different coefficient of thermal expansion from that of diamond and, as such, upon heating of the polycrystalline diamond material during use, the cobalt in the substrate to which the PCD material is attached expands and may cause cracks to form in the PCD material, resulting in the deterioration of the PCD layer.

It is desirable to improve the abrasion resistance of a body of PCD material when used as an abrasive compact in tools such as those mentioned above, as this allows extended use of the cutter, drill or machine in which the abrasive compact is located. This is typically achieved by manipulating variables such as average diamond particle/grain size, overall binder content, particle density and the like.

For example, it is well known in the art to increase the abrasion resistance of an ultra-hard composite by reducing the overall grain size of the component ultra-hard particles. Typically, however, as these materials are made more wear resistant they become more brittle or prone to fracture.

Abrasive compacts designed for improved wear performance will therefore tend to have poor impact strength or reduced resistance to spelling. This trade-off between the properties of impact resistance and wear resistance makes designing optimised abrasive compact structures, particularly for demanding applications, inherently self-limiting.

Additionally, because finer grained structures will typically contain more solvent/catalyst or metal binder, they tend to exhibit reduced thermal stability when compared to coarser grained structures. This reduction in optimal behaviour for finer grained structures can cause substantial problems in practical applications where the increased wear resistance is nonetheless required for optimal performance.

Prior art methods to solve this problem have typically involved attempting to achieve a compromise by combining the properties of both finer and coarser ultra-hard particle grades in various manners within the ultra-hard abrasive layer.

Another conventional solution is to remove, typically by acid leaching, the catalyst/solvent or binder phase from the PCD material.

Impurities present in the PCD material may also have an adverse effect on performance of the material in its end application. This is particularly noticeable when the PCD material has been subjected to a leaching treatment where, whilst such a treatment may remove residual solvent-catalyst present in interstices between the interbonded diamond grains, it may not be suitable also to remove impurities which could adversely affect the quality and strength of the bonding between adjacent diamond grains rendering the material susceptible to early failure in end applications. Examples of such impurities may include oxygen which may be in the form of chemisorbed oxygen present on the surfaces of the diamond grains forming the PCD material. In conventional PCD, the level of such oxygen in PCD may typically be at least 500 ppm to 1000 ppm or more.

Common problems that affect cutting elements are chipping, spalling, partial fracturing, and cracking of the ultra-hard material layer. These problems may result in the early failure of the ultra-hard material layer and thus in a shorter operating life for the cutting element. Accordingly, there is a need for a cutting element having an enhanced operating life in high wear or high impact applications, such as boring into rock, with an ultra-hard material layer in which the likelihood of cracking, chipping, spalling and/or fracturing is reduced, such that the abrasive compact may achieve improved properties of impact and fatigue resistance, whilst still retaining good wear resistance and reduced incidence of cracking or spalling.

### SUMMARY

Viewed from a first aspect there is provided a polycrystalline super hard construction comprising a body of polycrystalline diamond (PCD) material and a plurality of interstitial regions between inter-bonded diamond grains forming the polycrystalline diamond material; the body of PCD material comprising:
a working surface positioned along an outside portion of the body;
a first region adjacent the working surface, the first region being a thermally stable region; wherein
the first region and/or a further region and/or the body of PCD material has/have an average oxygen content of less than around 300 ppm.

Viewed from a second aspect there is provided a method of forming a polycrystalline super hard construction, comprising:
providing a mass of diamond grains;
treating the mass of diamond grains at a temperature of between around 1100 to around 2000 degrees C. in a vacuum-controlled environment for a predetermined period to reduce the oxygen content of the diamond grains and to form a pre-sinter mass of diamond grains;
treating the pre-sinter mass of diamond grains in the presence of a catalyst/solvent material for the diamond grains at an ultra-high pressure of around 5.5 GPa or greater and a temperature at which the diamond material is more thermodynamically stable than graphite to sinter together the diamond grains to form a polycrystalline diamond construction, the diamond grains exhibiting inter-granular bonding and defining a plurality of interstitial regions therebetween, a non-superhard phase at least partially filling a plurality of the interstitial regions; and
treating the polycrystalline diamond construction to render a first region thereof thermally stable; wherein
the first region and/or a further region and/or the body of PCD material has/have an average oxygen content of less than around 300 ppm PCD material has/have an average oxygen content of less than around 300 ppm.

Viewed from a third aspect there is provided an earth boring drill bit comprising a body having any of the aforementioned super hard constructions mounted thereon as a cutter element.

### BRIEF DESCRIPTION OF DRAWINGS

Non-limiting embodiments will now be described by way of example and with reference to the accompanying drawings in which:

FIG. 1 is a schematic drawing of the microstructure of a body of PCD material;

FIG. 2 is a schematic drawing of a PCD compact comprising a PCD structure bonded to a substrate;

FIG. 3 is plot of temperature against time for an example of a first heat treatment stage for starting materials prior to sintering of the materials; and

FIG. 4 is a plot of wear scar area against cutting length in a vertical borer test for two examples.

### DETAILED DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material and a substrate attached thereto.

As used herein, polycrystalline diamond (PCD) is a type of polycrystalline super hard material (PCS) material comprising a mass of diamond grains, a substantial portion of which are directly inter-bonded with each other and in which the content of diamond is at least about 80 volume percent of the material. In one embodiment of PCD material, interstices between the diamond grains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

As used herein, a “PCD structure” comprises a body of PCD material.

As used herein, PCBN (polycrystalline cubic boron nitride) material refers to a type of super hard material comprising grains of cubic boron nitride (cBN) dispersed within a matrix comprising metal or ceramic. PCBN is an example of a super hard material.

A “catalyst material” for a super hard material is capable of promoting the growth or sintering of the super hard material. As used herein, “catalyst material” for diamond, which may also be referred to as solvent/catalyst material for diamond, means a material that is capable of promoting the growth of diamond or the direct diamond-to-diamond inter-growth between diamond grains at a pressure and temperature condition at which diamond is thermodynamically stable.

A “filler” or “binder material” is understood to mean a material that wholly or partially fills pores, interstices or interstitial regions within a polycrystalline structure.

The term “substrate” as used herein means any substrate over which the ultra-hard material layer is formed. For example, a “substrate” as used herein may be a transition layer formed over another substrate.

As used herein, a “metallic” material is understood to comprise a metal in unalloyed or alloyed form and which has characteristic properties of a metal, such as high electrical conductivity.

A multi-modal size distribution of a mass of grains is understood to mean that the grains have a size distribution with more than one peak, each peak corresponding to a respective “mode”. Multimodal polycrystalline bodies may be made by providing more than one source of a plurality of grains, each source comprising grains having a substantially different average size, and blending together the grains or particles from the sources. In one embodiment, the PCD structure may comprise diamond grains having a multimodal distribution.

Like reference numbers are used to identify like features in all drawings.

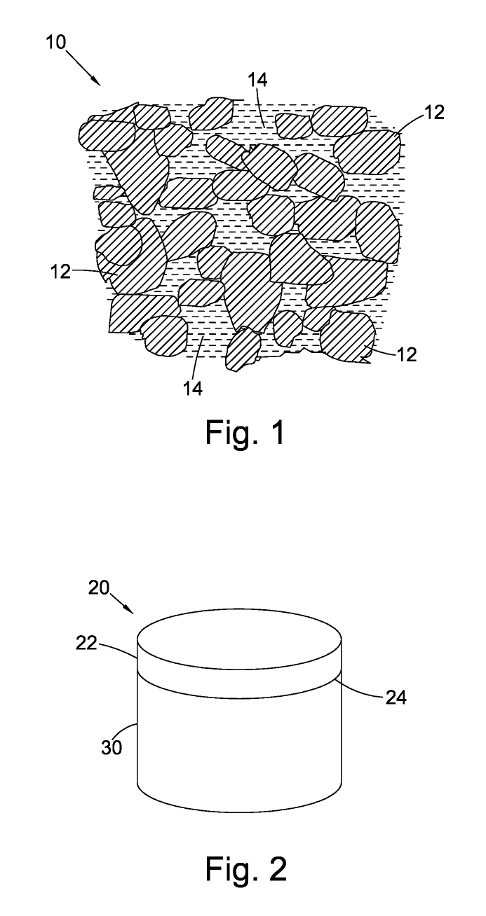

With reference to FIG. 1, a body of PCD material 10 comprises a mass of directly inter-bonded diamond grains 12 and interstices 14 between the diamond grains 12, which may be at least partly filled with filler or residual solvent/catalyst (binder) material.

FIG. 2 shows an embodiment of a PCD composite compact 20 (a super hard construction) for use as a cutter comprising a body of PCD material 22 integrally bonded at an interface 24 to a substrate 30. The substrate 30 may be formed of, for example, cemented carbide material and may be, for example, cemented tungsten carbide, cemented tantalum carbide, cemented titanium carbide, cemented molybdenum carbide or mixtures thereof. The binder metal for such carbides may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline diamond material 22 during formation of the compact 20.

The super hard construction 20 shown in FIG. 1 may be suitable, for example, for use as a cutter insert for a drill bit for boring into the earth.

An example of a method for producing the PCD compact 20 comprising the body of PCD material 22, as shown in FIGS. 1 and 2, is now described.

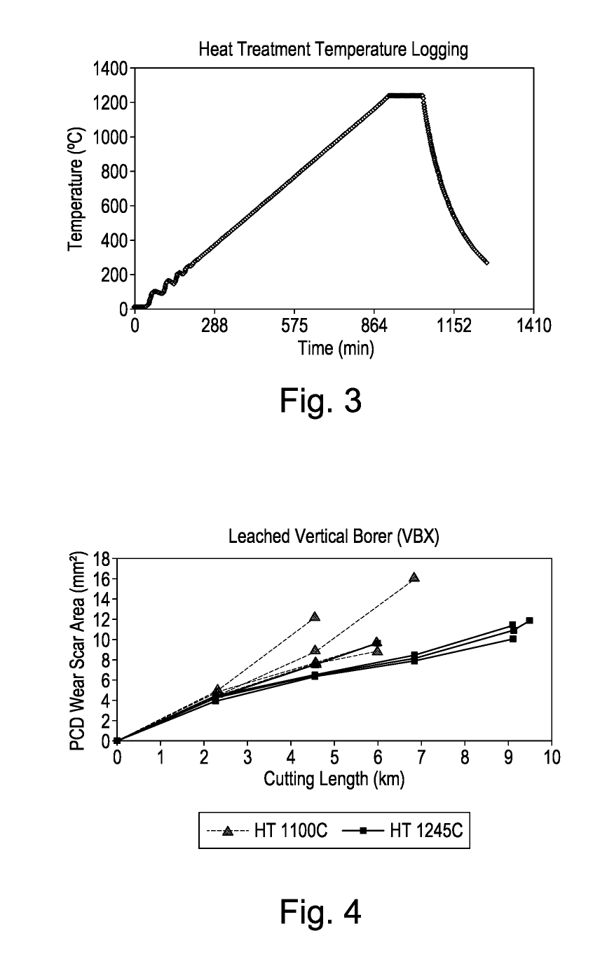

It has been appreciated that all powders have the propensity to adsorb gases from the surrounding atmosphere, creating an oxide film on the surface of super hard particles such as diamond particles which may adversely influence densification during sintering, leading to undesired microstructures and consequently inferior mechanical properties of the sintered super hard construction. To minimise contaminants (mostly chemisorbed oxygen) prior to sintering, the starting diamond powder mix/mixes were placed into alumina crucibles, which were then placed into a graphite pot/pots for containment. The diamond powder mixes were then subjected to a heat treatment of between around 1100 to around 2000 degrees C. for a desired period of time, for example one hour, in a vacuum-controlled environment. In one example, as shown in FIG. 3, the heat treatment was performed at a heating rate of 1.5° C./min, in a vacuum controlled environment (<10⁻⁴ mbar) and the dwell time was 1hour at 1245° C.

In some embodiments, this heat treated diamond powder mixture(s) was then placed in a canister adjacent a pre-formed substrate to form a pre-sinter assembly and subjected to an ultra-high pressure of at least about 5.5 GPa and a high temperature of at least about 1,300 degrees centigrade to sinter the diamond grains and form a PCD element comprising a PCD structure integrally joined to the substrate.

In some embodiments, a second outgassing cycle and heat treatment may be applied in which the diamond mix that has already been subjected to the first heat treatment described above, together with the pre-formed substrate or green body that is to form the substrate, is subjected to a further heat treatment at a lower temperature than the first heat treatment step, for example, at a temperature of around 1100 degrees C. in a vacuum-controlled environment to form the pre-sinter assembly. The pre-sinter assembly may then be placed into a capsule for an ultra-high pressure press and subjected to an ultra-high pressure of at least about 5.5 GPa and a high temperature of at least about 1,300 degrees centigrade to sinter the diamond grains and form a PCD element comprising a PCD structure integrally joined to the substrate.

In one version of the method, when the pre-sinter assembly is treated at the ultra-high pressure and high temperature, the binder material within the support body melts and infiltrates the diamond grains. The presence of the molten catalyst material from the substrate body is likely to promote the sintering of the diamond grains by intergrowth with each other to form an integral, PCD structure.

In some embodiments, both the bodies of super hard material 22 and substrate material 30 plus sintering aid/binder/catalyst are applied as powders and are sintered simultaneously in a single UHP/HT process. In the example where the super hard grains comprise diamond and the substrate 30 is formed of carbide material, the diamond grains, following the pre-sinter heat treatment described above to reduce chemisorbed oxygen, and mass of carbide to form the substrate 30 which may or may not have been subjected to a heat treatment process described above with the diamond grains as a second heat treatment thereof, are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one embodiment, the processing conditions generally involve the imposition for about 3 to 120 minutes of a temperature of at least about 1200 degrees C. and an ultra-high pressure of greater than about 5 GPa.

In some embodiments, the substrate 30 may be pre-sintered in a separate process before being bonded together in the HP/HT press during sintering of the super hard polycrystalline material.

In a further embodiment, both the substrate 30 and a body of polycrystalline super hard material 22 are pre-formed. For example, the bimodal or multimodal feed of super hard grains/particles with optional carbonate binder-catalyst also in powdered form are mixed together, and are subjected to a first heat treatment prior to sintering by heating the mixture at a temperature of least around 1200 degrees C. for a desired period of time, for example one hour, in a vacuum-controlled environment. The mixture is then packed into an appropriately shaped canister and is subjected to extremely high pressure and temperature in a press. Typically, the pressure is at least 5 GPa and the temperature is at least around 1200 degrees C. The preformed body of polycrystalline super hard material is then placed in the appropriate position on the upper surface of the preformed carbide substrate (incorporating a binder catalyst), and the assembly is located in a suitably shaped canister. The assembly is then subjected to high temperature and pressure in a press, the order of temperature and pressure being again, at least around 1200 degrees C. and at least around 5 GPa or more respectively. During this process the solvent/catalyst migrates from the substrate into the body of super hard material and acts as a binder-catalyst to effect intergrowth in the layer and also serves to bond the layer of polycrystalline super hard material to the substrate. The sintering process also serves to bond the body of super hard polycrystalline material to the substrate.

The substrate 30 forms a support body which may comprise cemented carbide in which the cement or binder material comprises a catalyst material for diamond, such as cobalt.

In some versions of the method, the aggregate masses may comprise substantially loose diamond grains, or diamond grains held together by a binder material. The aggregate masses of grains may contain catalyst material for diamond and/or additives for reducing abnormal diamond grain growth, for example, or the aggregated mass may be substantially free of catalyst material or additives. In some embodiments, the aggregate masses may be assembled onto a cemented carbide support body following heat treatment described above to reduce the presence of chemisorbed oxygen.

In some embodiments, the pre-sinter assembly may be subjected to a pressure of at least about 6 GPa, at least about 6.5 GPa, at least about 7 GPa or even at least about 7.7 GPa or greater.

After forming the body of sintered polycrystalline material, a finishing treatment is applied to treat the body of super-hard material 22 to remove residual sinter catalyst from at least some of the interstices between the inter-bonded grains to form a thermally stable region in the body of PCD material and to assist in improving thermal stability of the sintered structure. In particular, catalyst material may be removed from a region of the PCD structure 22 adjacent an exposed surface thereof. Generally, that surface will be on a side of the polycrystalline layer opposite to the substrate and will provide a working surface for the polycrystalline diamond layer and/or the side surface or both the working surface and the side surface. Removal of the catalysing material may be carried out using methods known in the art such as electrolytic etching, and acid leaching and evaporation techniques. For example, this may be done by treating the PCD structure 22 with acid to leach out catalyst material from between the diamond grains, or by other methods such as electrochemical methods. A thermally stable region, which may be substantially porous, may, for example extend throughout the whole body of the PCD material such that the entire body of PCD material is thermally stable or it may extend to a certain depth of, for example, less than 100 microns from the working surface of the body of PCD material or more than 100 microns such as at least about 300 microns or at least about 600 microns or at least about 800 microns or at least about 1000 microns from the working surface 36 of the PCD structure 22. In some examples, the substantially porous thermally stable region may comprise at most 2 weight percent of catalyst material.

In embodiments where the cemented carbide substrate does not contain sufficient solvent/catalyst for diamond, and where the PCD structure is integrally formed onto the substrate during sintering at an ultra-high pressure, solvent/catalyst material may be included or introduced into the aggregated mass of diamond grains from a source of the material other than the cemented carbide substrate. The solvent/catalyst material may comprise cobalt that infiltrates from the substrate in to the aggregated mass of diamond grains just prior to and during the sintering step at an ultra-high pressure. However, in embodiments where the content of cobalt or other solvent/catalyst material in the substrate is low, particularly when it is less than about 11 weight percent of the cemented carbide material, then an alternative source may need to be provided in order to ensure good sintering of the aggregated mass to form PCD.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step.

In another embodiment, cobalt powder or precursor to cobalt, such as cobalt carbonate, may be blended with the diamond grains before sintering the aggregated mass and subjected to the heat treatment process prior to sintering described above with the diamond grains to reduce the amount of oxygen present.

The grains of super hard material, such as diamond grains or particles in the starting mixture prior to sintering may be, for example, bimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some embodiments, range for example between about 0.1 to 20 microns.

In some embodiments, the weight ratio of the coarse diamond fraction to the fine diamond fraction ranges from about 50% to about 97% coarse diamond and the weight ratio of the fine diamond fraction may be from about 3% to about 50%. In other embodiments, the weight ratio of the coarse fraction to the fine fraction will range from about 70:30 to about 90:10.

In further embodiments, the weight ratio of the coarse fraction to the fine fraction may range for example from about 60:40 to about 80:20.

In some embodiments, the particle size distributions of the coarse and fine fractions do not overlap and in some embodiments the different size components of the compact are separated by an order of magnitude between the separate size fractions making up the multimodal distribution.

The embodiments may comprise at least a wide bi-modal size distribution between the coarse and fine fractions of super hard material, and some embodiments may include three or even four or more size modes which may, for example, be separated in size by an order of magnitude, for example, a blend of particle sizes whose average particle size is 20 microns, 2 microns, 200 nm and 20 nm.

In some embodiments, the average grain size of the aggregated mass of super hard grains is less than or equal to 25 microns. In some embodiments, the average grain size is between around 8 to 20 microns.

Sizing of diamond particles/grains into fine fraction, coarse fraction, or other sizes in between, may be through known processes such as jet-milling of larger diamond grains and the like.

In embodiments where the super hard material is polycrystalline diamond material, the diamond grains used to form the polycrystalline diamond material may be natural or synthetic.

The body of super hard material 12 shown in FIG. 1 may, in some embodiments, be a layered construction or have multiple regions.

In some embodiments, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some embodiments, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some embodiments, the metal carbide is tungsten carbide.

Polycrystalline bodies formed according to the above-described method may have many applications. For example, they may be used as an insert for a machine tool, in which the cutter structure comprises the body of polycrystalline super hard material according to one or more embodiments.

Embodiments are described in more detail below with reference to the following example which is provided herein by way of illustration only and is not intended to be limiting.

### EXAMPLE

This non-limiting example illustrates a method of forming a compact 20.

A total of around 1.81 g of diamond powder having an average grain size of around 12.6 microns and 1 wt % admixed Cobalt powder having an average diameter of between around 1 to 3 microns is placed into an alumina crucible, which is then placed into a graphite pot for containment. The diamond powder mix is then subjected to a heat treatment at a heating rate of 1.5° C./min, in a vacuum controlled environment (<10⁻⁴ mbar) and the dwell time is 1 hour at 1245° C. The heat treated diamond mixture is then placed into the bottom of a metal cup. A plastic plug is then placed into the cup, and the cup, powder and plug are vibration compacted for a given period of time. The plug is carefully removed, taking care not to disturb the flat surface of the diamond powder. This is to form a first layer in the sintered product.

To form a second layer, a total of around 1.16 g of diamond powder having an average grain size of around 25.3 microns and 1 wt % admixed Cobalt powder having a diameter of between around 1 to 3 microns is placed into an alumina crucible, which is then placed into a graphite pot for containment. The diamond powder mix is then subjected to a heat treatment at a heating rate of 1.5° C./min, in a vacuum controlled environment (<10⁻⁴ mbar) and the dwell time is 1 hour at 1245° C. The heat treated diamond mixture is then placed into the cup on top of the first layer of diamond powder and pressed down with another, shorter plastic plug. The plug, diamond powders and cup are then subjected to further vibration compaction. At the end of this compaction cycle, the plug is removed, and a pre-formed tungsten carbide cylinder is inserted into the cup to form the substrate 30. A second heat treatment process is applied to the diamond mixes and the pre-formed substrate whereby the pre-sinter assembly comprising the diamond mixes and substrate is subjected to a further heat treatment at a lower temperature than the first heat treatment step, for example, at a temperature of around 1100 degrees C. in a vacuum-controlled environment to form a pre-compact assembly. Additional metal cups may be pressed over the unit to complete the pre-compact assembly either before or after the second heat treatment stage.

The pre-compact assembly is then subjected to an ultra-high pressure of at least about 5.5 GPa and a temperature of at least about 1,250 degrees centigrade to melt the cobalt comprised in the substrate body and sinter the diamond grains to each other to form a composite compact comprising a PCD structure formed joined to the substrate. After sintering, the PCD structure may be further processed, depending on its intended application. For example, it may be further treated by grinding and/or polishing. It is also subjected to a further treatment to render at least a portion of the PCD thermally stable, for example, by treating the PCD body in acid to remove residual cobalt within interstitial regions between the inter-grown diamond grains, in accordance with a conventional leaching process such as that described in U.S. Pat. No. 7,972,395. Removal of a substantial amount of cobalt from the PCD structure is likely to increase substantially the thermal stability of the PCD structure and will likely reduce the risk of degradation of the PCD material.

The body 22 of PCD so formed had a total thickness of the two layers of around 2.0 to around 3.0 mm.

To produce the pre-formed body of cemented carbide to form the substrate 30 of the composite compact 20, a green body is formed by mixing, for example, WC grains with Co which is homogenously dispersed in the mixture sufficient to create a sintered product having between around 9 to around 11 wt % Co. A small amount of PEG is included to act as a binder, for example around 1-2 wt %. The green body is sintered at a temperature of around 1400 deg C. for a dwell time of between around 1 to 2 hours, firstly in a hydrogen atmosphere to burn off the PEG, and then in a vacuum for final carbide sintering. The overall sintering time to create the pre-formed substrate 30 may be, for example, around 24 hours.

Prior to sintering, the green body is pressed in a die-set with a punch having the required interface design.

In order to test the amount of oxygen present in the sintered PCD product formed according to the above method, a first example product was made according to the example described above. A standard commercially available oxygen determinator machine such as that produced and sold by LECO, for example, the TC500 Nitrogen/Oxygen Determinator was used which measures the oxygen (and nitrogen) content of a sample and uses a self-contained electrode furnace for fusion. An empty graphite crucible is firstly out-gassed during which the atmosphere is purged from the crucible. A high current is then passed through the crucible generating heat, which drives off gases trapped in the graphite. The PCD sample to be analysed is dropped into the crucible. High current is passed through the crucible driving off gases in the sample. To prevent further out-gassing during analysis, a current lower than the out-gas current is used. The oxygen released from the sample combines with the carbon from the crucible to form carbon monoxide and small amounts of carbon dioxide. Any carbon monoxide formed in the fusion is first passed through the heated rare earth copper oxide, which converts carbon monoxide to carbon dioxide, and then the carbon dioxide is measured by an IR cell.

For comparison, a second PCD compact was produced in which only the first heat treatment was applied to the diamond grains prior to sintering rather than subjecting the diamond grains to the second heat treatment with the substrate, prior to sintering and a sample of the PCD compact was subjected to the method above to measure the amount of oxygen present.

Furthermore, the oxygen levels in the pre-sintered diamond grain mixtures of grains that had been subjected to a single heat treatment stage and those that had been subjected to the second heat treatment stage were also measured using the same method described above with respect to the analysis of the sintered PCD articles. Namely, the sample was heated to a temperature of around 2500 to 3000° C. in a graphite crucible under a stream of helium. Oxides in the sample react with the graphite crucible to form either carbon monoxide or carbon dioxide and are swept away in the helium. The gas stream is passed over a heated bed of copper oxide to convert any carbon monoxide to carbon dioxide. So all the oxygen from the sample is now present as carbon dioxide and this is quantified using infra-red spectroscopy. The instrument is calibrated using steel pin standards with known oxygen levels. A second sample that had been subjected to the additional heat treatment prior to sintering was similarly analysed to determine the oxygen content in the diamond grain mixture of that sample.

For reference, the oxygen content of the mixture of diamond grains that had not been subjected to the heat treatment stage(s) prior to sintering was measured using the above method. It was found that the oxygen content present in the pre-sintered diamond grains was lowered from 1100 ppm to around 200 ppm. When the second heat treatment was applied, around an additional 50 ppm oxygen reduction was achieved in the pre-sintered diamond grains. Similarly, in the sintered PCD articles, it was found that the oxygen content present in the PCD sample that had been subjected to the single heat treatment described above prior to sintering had an oxygen content of less than around 300 ppm, and was around 200 ppm. When the second heat treatment was applied, the oxygen content in the PCD sample was less, at around 150 ppm.

Whilst not wishing to bound by any particular theory, it is believed that reducing the oxygen content in the pre-composite prior to sintering, will assist in achieving smooth, clean binder infiltration, improved wettability and strong diamond-diamond bonding. Furthermore, it is believed that through a higher temperature treatment of the starting diamond powder mixes, a greater volume of chemisorbed oxygen species on the diamond particles may be removed. Consequently, this may facilitate densification by allowing for cleaner binder infiltration and improved wettability during the synthesis cycle as well as increased graphitization and reduced intrinsic impurity contents.

It is expected that increasing the treatment temperature should increase the solid-state diffusion limit of carbon atoms into the binder phase. For 1245° C., the solid solubility of carbon increases to around 3.5 at %, from the around 2 at % achieved when treating the starting materials at simply 1100° C. alone prior to sintering. It is believed that this increased carbon diffusion may lead to increased re-precipitation as graphite during subsequent cooling. Consequently, higher graphite formation is associated with an increase in the diamond lattice strain due to a 54% volumetric change resulting from diamond to graphite conversion. As a result, it is believed that surface cracks/defects and stresses are generated leading to increased reactivity and higher driving forces for synthesis. Additionally, greater densities may be achieved due to reduced roughness and friction between particles and compaction during sintering would be accelerated due to mutual sliding of particles.

In order to test the abrasion/wear resistance of the sintered polycrystalline products formed according to the above methods, a first example product (made according to the example described above) was formed and the sintered product was leached for a sufficient leach time to achieve a leach depth of around 350 microns. For comparison, a product whose diamond grains had been subjected solely to a heat treatment of around 1100 degrees C. prior to sintering and having a leach depth from the working surface of around 350 microns was produced.

The diamond layers of the two compacts were then polished and a subjected to a vertical boring mill test. In this test, the wear flat area is measured as a function of the number of passes of the cutter element boring into the workpiece. The results obtained are illustrated graphically in FIG. 4. The results provide an indication of the total wear scar area plotted against cutting length.

It will be seen that the PCD compacts formed according to Example 1 were able to achieve a significantly greater cutting length than the test compact, achieving in this example, a 30% improvement in the average cutting length performance was achieved at the 4.56 km mark over the cutters that had only been subjected to a single pre-sintering heat treatment at the lower temperature. In addition, the cutters formed according to the described example showed improved spalling resistance compared to the cutters formed of diamond grains that had been subjected to a single lower heat treatment prior to sintering. A 57% cutter life improvement was achieved. The data also shows consistent performance in abrasion resistance and spalling behaviour. Whilst not wishing to be bound by any particular theory, it is believed that this improvement may be due to shrinkage and density benefits achieved through the higher temperature treatment, thereby allowing for a highly deformed, tightly compacted PCD structure.

It was also found that PCD compacts formed according to the above examples may result in an increase in yield during the production process due to a reduction in sintering defects which may have beneficial cost savings. Again, whilst not wishing to be bound by theory, it is believed that the lower oxygen content, reduction in fine grain particles and increased graphitisation levels may facilitate sintering of the PCD material. The benefits achieved from one or more of these may contribute to an overall improvement in sinter quality, by increasing density, accelerating compaction and allowing for cleaner binder infiltration during sintering. As such, diamond-diamond intergrowth may be enhanced and an increase in abrasion resistance performance may be achieved.

In some embodiments, the polycrystalline bodies formed according to the above-described methods may be used as a cutter for boring into the earth, or as a PCD element for a rotary shear bit for boring into the earth, or for a percussion drill bit or for a pick for mining or asphalt degradation. Alternatively, a drill bit or a component of a drill bit for boring into the earth, may comprise the body of polycrystalline super hard material according to any one or more embodiments.

Although particular embodiments have been described and illustrated, it is to be understood that various changes and modifications may be made and equivalents may be substituted for elements thereof and that these examples are not intended to limit the particular embodiments disclosed. For example, the substrate described herein has been identified by way of example. It should be understood that the super hard material may be attached to other carbide substrates besides tungsten carbide substrates, such as substrates made of carbides of W, Ti, Mo, Nb, V, Hf, Ta, and Cr.

Furthermore, although the embodiment shown in FIG. 1 is depicted in these drawings as comprising PCD structures having sharp edges and corners, embodiments may comprise PCD structures having rounded, bevelled or chamfered edges or corners. Such embodiments may reduce internal stress and consequently extend working life through improving the resistance to cracking, chipping, and fracturing of cutting elements through the interface of the substrate or the super hard material layer having unique geometries.

Furthermore, various example arrangements and combinations for cutter structures and inserts are envisaged by the disclosure. The cutter structure may comprise natural or synthetic diamond material. Examples of diamond material include polycrystalline diamond (PCD) material, thermally stable PCD material, crystalline diamond material, diamond material made by means of a chemical vapour deposition (CVD) method or silicon carbide bonded diamond and in one or more other embodiments, the super hard polycrystalline structure described herein may form a PCD element for one or more of a rotary shear bit for boring into the earth, a percussion drill bit, or a pick for mining or asphalt degradation.

1. A polycrystalline super hard construction comprising a body of polycrystalline diamond (PCD) material and a plurality of interstitial regions between inter-bonded diamond grains forming the polycrystalline diamond material; the body of PCD material comprising:
a working surface positioned along an outside portion of the body;
a first region adjacent the working surface, the first region being a thermally stable region; wherein
the first region and/or a further region and/or the body of PCD material has/have an average oxygen content of less than around 300 ppm.

2. The polycrystalline super hard construction of claim 1, wherein the first region is substantially free of a solvent/catalysing material for diamond.

3. The polycrystalline super hard construction of claim 1, further comprising the further region, the further region being remote from the working surface and comprising solvent/catalysing material in a plurality of the interstitial regions; wherein the oxygen content of the further region is less than around 300 ppm.

4. The polycrystalline super hard construction of claim 1, wherein the thermally stable region and/or a further region and/or the body of PCD material has/have an average oxygen content of between around 10 ppm to around 300 ppm.

5. The polycrystalline super hard construction of claim 1, wherein the thermally stable region and/or a further region and/or the body of PCD material has/have an average oxygen content of between around 10 ppm to around 200 ppm.

6. (canceled)

7. The polycrystalline super hard construction of claim 1, wherein the thermally stable region and/or a further region and/or the body of PCD material has/have an average oxygen content of between around 10 ppm to around 100 ppm.

8. The polycrystalline super hard construction of claim 1, wherein the thermally stable region and/or a further region and/or the body of PCD material has/have an average oxygen content of between around 10 ppm to around 50 ppm.

9. (canceled)

10. (canceled)

11. (canceled)

12. (canceled)

13. (canceled)

14. The polycrystalline super hard construction of claim 1, wherein the first region extends to a depth of between around 50 microns to around 1500 microns from the working surface into the body of polycrystalline diamond material.

15. (canceled)

16. The polycrystalline super hard construction as claimed in claim 1, wherein the thermally stable region comprises at most 2 weight percent of catalyst material for diamond.

17. (canceled)

18. A method of forming a polycrystalline super hard construction, comprising:
providing a mass of diamond grains;
treating the mass of diamond grains at a temperature of between around 1100 to around 2000 degrees C. in a vacuum-controlled environment for a predetermined period to reduce the oxygen content of the diamond grains and to form a pre-sinter mass of diamond grains;
treating the pre-sinter mass of diamond grains in the presence of a catalyst/solvent material for the diamond grains at an ultra-high pressure of around 5.5 GPa or greater and a temperature at which the diamond material is more thermodynamically stable than graphite to sinter together the diamond grains to form a polycrystalline diamond construction, the diamond grains exhibiting inter-granular bonding and defining a plurality of interstitial regions therebetween, a non-superhard phase at least partially filling a plurality of the interstitial regions; and
treating the polycrystalline diamond construction to render a first region thereof thermally stable; wherein
the first region and/or a further region and/or the body of PCD material has/have an average oxygen content of less than around 300 ppm.

19. The method of claim 18, wherein, the step of providing a mass of diamond grains comprises providing a mass of diamond grains having a first fraction having a first average size and a second fraction having a second average size, the first fraction having an average grain size ranging from about 10 to 60 microns, and the second fraction having an average grain size less than the size of the first fraction.

20. The method of claim 19, wherein the second fraction has an average grain size between around 1/10 to 6/10 of the size of the first fraction.

21. The method of claim 19, wherein the average grain size of the first fraction is between around 10 to 60 microns, and the average grain size of the second fraction is between about 0.1 to 20 microns.

22. The method of claim 19, wherein the first fraction comprises from about 50% to about 97% by weight % of the mass of diamond grains and the second fraction comprises from about 3% to about 50 weight % of the mass of diamond grains.

23. (canceled)

24. The method of claim 22, wherein the ratio by weight percent of the first fraction to the second fraction is around 70:30.

25. The method of claim 22, wherein the ratio by weight percent of the first fraction to the second fraction is around 90:10.

26. (canceled)

27. The method of claim 18, further comprising after the stage of treating the diamond grains which forms a first stage, a second stage of treating the diamond grains and any substrate to be attached to the diamond grains during sintering at a temperature lower than the temperature of the first stage in a vacuum-controlled environment for a predetermined period to reduce further the oxygen content of the diamond grains and to form a pre-sinter assembly.

28. The method of claim 27, wherein the temperature in the first stage is around 1200 degrees C. or greater and the temperature in the second stage is between around 1000 degrees C. and 1150 degrees C.

29. The method claim 18, wherein the step of providing a mass of grains of superhard material comprises providing three or more grain size modes to form a multimodal mass of grains comprising a blend of grain sizes having associated average grain sizes.

30. The method of claim 18, wherein the step of treating the polycrystalline diamond construction to render a first region thereof thermally stable comprises treating the first region to render the first region substantially free of a solvent/catalysing material for diamond.

31. (canceled)

32. (canceled)

33. (canceled)

34. (canceled)

35. (canceled)

36. (canceled)

37. (canceled)
